(19) United States
(12) Patent Application Publication
(10) Pub. No.: US 2007/0057635 A1
(43) Pub. Date: Mar. 15, 2007

(54) Halogen dual-beam lamp

(76) Inventors: Mathias Hubertus Johannes Van Rijswick, Eindhoven (NL); Denis Joseph Carel Van Oers, Eindhoven (NL); Andreas Martinus Theodorus Paulus Van Der Putten, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/550,351

(22) PCT Filed: Mar. 22, 2004
(86) PCT No.: PCT/IB04/50311

§ 371 Date: Sep. 23, 2005

(30) Foreign Application Priority Data
Mar. 28, 2003 (EP) 03100808.9

(51) Int. Cl. H01K 1/50

(52) U.S. Cl. 313/579

(57) ABSTRACT

This invention relates to a lamp-reflector unit (3) provided with a first (15) and a second filament (17) axially disposed on a lamp axis (1), and a circularly symmetrical reflector (7) with a reflecting part (13). The use of a modified low-voltage H4 automotive halogen lamp leads to a relatively cheap lamp-reflector unit for application in shop and home lighting enabling direct switching from spot-lighting to flood-lighting.

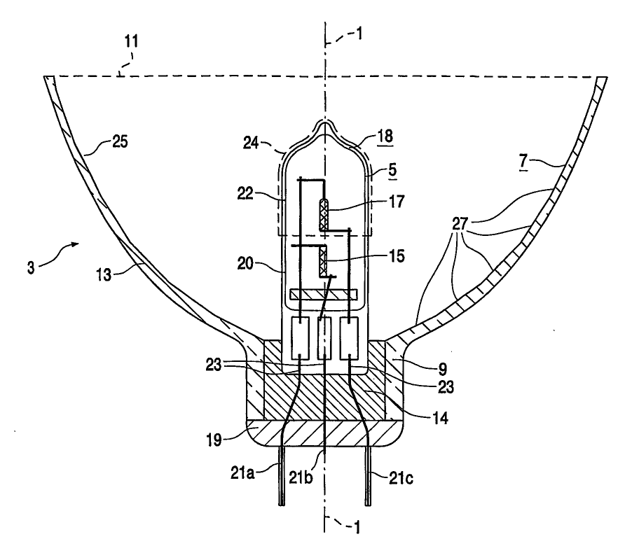

The invention relates to a lamp-reflector unit comprising:

a reflector with a neck, a light emission window, a circularly symmetrical reflecting portion arranged around an optical axis extending through the neck and perpendicular to the light emission window, which reflecting portion extends from the neck up to the light emission window;

a lamp comprising an end portion, a first filament, and a second filament, said first and second filaments being located one behind the other, axially on the optical axis such that the first filament is located closer to the neck than the second filament;

a lamp cap mounted to the neck and provided with electrical contacts and with current conductors connected to the latter and to the respective filaments.

Such a lamp-reflector unit is known from EP-168015. The known unit comprises a low-power lamp of which the first and the second filament form one whole because they have been manufactured from a single wire and are interconnected by a straight connecting portion of this wire. The two filaments have at least substantially the same resistance. The lamp in the known unit is mounted in the neck of the reflector so as to be displaceable along the optical axis. The known unit aims to provide a possibility of a mutual displacement of the lamp and the reflector in the case of failure of the filament located in a focus of the reflector such that the focus will be located on the other, still intact filament, so that as it were a double operational life of the lamp is achieved. The mutual displacement of the lamp and the reflector, or alternatively a switching between the filaments, renders it possible to vary the beam angle of the light beam somewhat. It is a disadvantage that the known unit has a comparatively complicated construction because of the mutual displaceability of lamp and reflector. Another disadvantage of the known unit is that the lamp specially manufactured for this unit is comparatively expensive.

It is an object of the invention to provide a lamp-reflector unit of the kind described in the opening paragraph in which the above disadvantages have been counteracted. To achieve this, the unit of the kind described in the opening paragraph is characterized in that the lamp is a modified, low-voltage, dual-filament halogen automobile lamp whose end portion is fixed in the neck of the reflector. An example of such a halogen automobile lamp is a conventional H4 lamp. The conventional H4 lamp is an internationally standardized lamp in automobile lighting and has the advantage that the dimensions and shape of the lamp are constant, as described in the standard documents E/ECE/TRANS/505. The conventional H4 lamp has been used until now in reflectors that are not circularly symmetrical so as to obtain an asymmetrical light beam specifically required for automobile lighting from the unit. The combination of the modified conventional H4 lamp with a circularly symmetrical reflector renders possible alternative applications such as home and shop lighting. The conventional H4 lamp is modified internally only, whereas its external dimensions and the like remain unchanged. The low-beam cap is removed from the conventional H4 lamp, the two filaments are placed in one another's extended directions on the optical axis, and a black coating on the lamp has been omitted. An advantage of the use of the modified H4 lamp is that it can be manufactured on the existing H4 production lines. The omission of a few manufacturing steps in the known, universal production process of the H4 lamp renders it possible to manufacture the modified H4 lamp in a simple and inexpensive manner with a high reproducibility, the more so since large-scale manufacturing installations are already available, so that comparatively large investments are counteracted. The fixation of the lamp in the neck achieves a simple construction of the lamp-reflector unit, so that it can be manufactured comparatively inexpensively. The operation of the first or the second filament, or both filaments, renders it possible to obtain three different light beams, each with a defined ray distribution, from the unit according to the invention.

In a favorable embodiment, the reflecting portion of the reflector is subdivided into facets. This gives the lamp-reflector unit the advantages that an (indistinct) image of the light source projected on an object illuminated by the lamp-reflector unit is counteracted and that the lamp-reflector unit is less sensitive to disturbances in the light beam if the light sources are not accurately located on the optical axis.

In another embodiment, the lamp-reflector unit according to the invention is characterized in that the lamp has a translucent wall comprising a first and a second wall portion which surround the first and the second filament, respectively, wherein at least one wall portion has a spectrally modifying effect on light originating from the filament and passing through the relevant wall portion. Such a spectrally modifying effect may be achieved in a simple manner in that at least one of the wall portions has a coating, for example an interference coating or an absorption coating, which causes a change in color and/or color temperature of the light. It is alternatively possible that the first wall portion and the second wall portion have mutually different glass compositions.

Embodiments of the lamp-reflector unit according to the invention are diagrammatically shown in the drawing, in which the sole FIGURE is a longitudinal sectional view of an embodiment of the lamp-reflector unit according to the invention.

The FIGURE shows a longitudinal section through an optical axis 1 of a lamp-reflector unit 3 comprising a lamp 5, a reflector 7 with a neck 9, a light emission window 11, and a circularly symmetrical reflecting portion 13 around the optical axis 1 extending from the neck to the light emission window. The optical axis extends through the neck and is perpendicular to the light emission window. The lamp is a low-voltage, i.e. 12 V, halogen incandescent lamp, in this case a modified H4 lamp with a length of approximately 50 mm and a maximum diameter of approximately 22 mm. The lamp is fixed in the neck of the reflector by means of cement 14 and comprises a first filament 15 and a second filament 17. The first and the second filament are situated one behind the other on the optical axis, at an axial distance from one another of approximately 6.5 mm in the Figure, such that the first filament lies closer to the neck than the second filament. The filaments are both manufactured from a separate wire. The filaments often have a rated power in a range of 20 to 100 W, the first filament in the figure having a rated power of 35 W and the second filament a rated power of 50 W. The lamp 5 has a wall 18 comprising a first wall portion 20 cylindrically surrounding the first filament 15 and a second wall portion 22 largely surrounding the second filament 17. The second wall portion has an interference coating 24 through which the major portion of the light originating from the second filament is passed and which causes a change in color temperature of the light from approximately 2900 K to approximately 4000 K. Light coming from the first filament will mostly pass through the first wall portion to the exterior without any spectral change. The first filament generates a narrow light beam and the second filament generates a wide light beam during lamp operation. The neck 9 is provided with a lamp cap 19 comprising electrical contacts 21a, 21b, 21c. The electrical contacts are connected to the respective filaments via respective current conductors 23 such that the first and/or second filament can be independently lit. This renders it possible for both filaments to be lit simultaneously, whereby a light beam of comparatively high luminous intensity is obtained. The reflecting portion is provided with vapor-deposited aluminum 25 serving as a reflecting layer, but alternatively the reflecting layer may be an interference coating.

1. A lamp-reflector unit comprising:
a reflector with a neck, a light emission window, a circularly symmetrical reflecting portion arranged around an optical axis extending through the neck and perpendicular to the light emission window, which reflecting portion extends from the neck up to the light emission window;
a lamp comprising an end portion, a first filament, and a second filament, said first and second filaments being located one behind the other, axially on the optical axis such that the first filament is located closer to the neck than the second filament;
a lamp cap mounted to the neck and provided with electrical contacts and with current conductors connected to the latter and to the respective filaments, characterized in that the lamp is a modified, low-voltage, dual-filament halogen automobile lamp whose end portion is fixed in the neck of the reflector.

2. A lamp-reflector unit as claimed in claim 1, characterized in that the lamp has a translucent wall comprising a first and a second wall portion which surround the first and the second filament, respectively, wherein at least one wall portion has a spectrally modifying effect on light originating from the filament and passing through the relevant wall portion.

3. A lamp-reflector unit as claimed in claim 2, characterized in that at least one of the wall portions comprises a coating.

4. A lamp-reflector unit as claimed in claim 1, characterized in that the reflecting portion of the reflector is subdivided into facets.
